(19) United States
(12) Patent Application Publication
(10) Pub. No.: US 2025/0327199 A1
(43) Pub. Date: Oct. 23, 2025

(54) Nitride Semiconductor Photoelectrode

(71) Applicant: Nippon Telegraph and Telephone Corporation, Tokyo (JP)

(72) Inventors: Sayumi Sato, Musashino-shi, Tokyo (JP); Yuya Uzumaki, Musashino-shi, Tokyo (JP); Akihiro Kono, Musashino-shi, Tokyo (JP); Takeshi Komatsu, Musashino-shi, Tokyo (JP)

(21) Appl. No.: 18/871,894

(22) PCT Filed: Jun. 10, 2022
(86) PCT No.: PCT/JP2022/023496

§ 371 Date: Dec. 5, 2024

(51) Int. Cl. C25B 11/087; C25B 11/075

(52) U.S. Cl. CPC C25B 11/087; C25B 11/075

(57) ABSTRACT

A nitride semiconductor photoelectrode including: a conductive membrane formed on a substrate; a porous nitride semiconductor membrane formed on the conductive membrane; and a promoter layer formed on the porous nitride semiconductor membrane. The promoter layer causes an oxidation reaction of water on a surface of the promoter layer.

### TECHNICAL FIELD

The present invention relates to a nitride semiconductor photoelectrode.

### BACKGROUND ART

A technique for accelerating water oxidation reactions and proton/carbon dioxide reduction reactions by light irradiation to a photoelectrode including a photocatalyst is called artificial photosynthesis. A technique for accelerating water oxidation reactions and proton/carbon dioxide reduction reactions by applying a voltage between a metallic oxidizing electrode and reducing electrode is called electrolysis of water and electrolytic reduction of carbon dioxide.

In particular, a water oxidation reaction and a proton reduction reaction are represented by Formulae (1) and (2). When a photocatalytic material is irradiated with light, electrons and holes are generated and separated in the photocatalytic material. Holes move to a surface of the photocatalytic material and contribute to water oxidation reactions. On the other hand, electrons move to a reducing electrode and contribute to proton reduction reactions. Such redox reactions proceed and cause water splitting reactions.

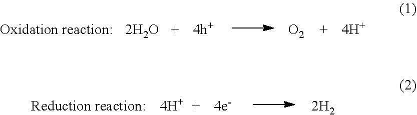

Artificial photosynthesis using sunlight and electrolysis/electrolytic reduction using electricity derived from renewable energy have attracted attention as technology capable of producing green hydrogen fuel as up-and-coming green energy, producing chemical substances using green hydrogen and carbon dioxide as raw materials, and recycling carbon dioxide (producing hydrocarbons such as carbon monoxide, formic acid, and ethylene and producing alcohols such as methanol and ethanol) and have been actively studied in recent years.

Based on Formulae (3) and (4), a ratio of Gibbs free energy change in hydrogen production to given light (or sunlight) energy is defined as sunlight conversion efficiency and is expressed by multiplication of a light absorbance and quantum yield. In order to improve the conversion efficiency, it is important to improve the light absorbance in a semiconductor membrane.

$$\begin{matrix}[ Math . 1 ] & \\ Sunlight conversion efficiency = \frac{Gibbs free energy change in hydrogen production}{Given light energy} = \frac{Absorbed light energy}{Given light energy} \times \frac{Gibbs free energy of produced hydrogen}{Absorbed light energy} & ( 3 )\end{matrix}$$

$$Light absorbance = \frac{Absorbed light energy}{Given light energy} \qquad ( 4 )$$

As a method for improving the light absorbance, it has been proposed to widen a wavelength range of absorption using a narrow-bandgap semiconductor material for a photoelectrode. Since tantalum nitride (Ta₃N₅) has a bandgap energy of about 2.1 eV and absorbs light having a wavelength of 600 nm or less, this nitride semiconductor is a prospective candidate as a material for a photoelectrode. Non Patent Literature 1 reports that water splitting reactions proceed by light irradiation using tantalum nitride as a photoelectrode.

### CITATION LIST

### Non Patent Literature

Non Patent Literature 1: Masanobu Higashi, and two others, “Fabrication of efficient TaON and Ta3N5 photoanodes for water splitting under visible light irradiation”, Energy & Environmental Science, 4, 2011, p. 4138-p. 4147

### SUMMARY OF INVENTION

### Technical Problem

Since it is difficult to grow a monocrystalline membrane of tantalum nitride, there is a method for obtaining a polycrystalline membrane of tantalum nitride by depositing tantalum oxide, followed by substituting nitrogen atoms for oxygen atoms (nitriding treatment). In this method, the membrane has a porous structure with pore sizes ranging from 1 nm to 100 nm due to a gas generated during the nitriding treatment or due to a volume change of the membrane caused by the nitrogen atom substitution.

When this porous polycrystalline semiconductor membrane is immersed in an aqueous solution and water splitting reactions proceed by light irradiation, water oxidation reactions proceed inside the polycrystalline semiconductor membrane and at an interface between the polycrystalline semiconductor membrane and a base substrate, thereby generating oxygen. This phenomenon induces detachment of the polycrystalline semiconductor membrane from the base substrate during desorption of the generated oxygen, which decreases the duration of a water splitting reaction.

The present invention has been made in light of the problems, and an object of the present invention is to prevent detachment of a porous nitride semiconductor membrane so as to increase the duration of a photoelectrochemical water splitting reaction.

### Solution to Problem

A nitride semiconductor photoelectrode according to an aspect of the present invention includes a conductive membrane formed on a substrate, a porous nitride semiconductor membrane formed on the conductive membrane, and a promoter layer formed on the porous nitride semiconductor membrane, in which the promoter layer causes an oxidation reaction of water on a surface of the promoter layer.

### Advantageous Effects of Invention

According to the present invention, it is possible to prevent detachment of a porous nitride semiconductor membrane, thereby increasing the duration of a photoelectrochemical water splitting reaction.

### BRIEF DESCRIPTION OF DRAWINGS

FIG. 1 is a view illustrating an example of a configuration of a nitride semiconductor photoelectrode according to this embodiment.

FIG. 2 is a view illustrating an outline of a device used for a redox reaction test.

### DESCRIPTION OF EMBODIMENTS

Hereinafter, an embodiment of the present invention will be described with reference to the drawings. The present invention is not limited to the following embodiment and may be modified without departing from the gist of the present invention.

### [Configuration of Semiconductor Photoelectrode]

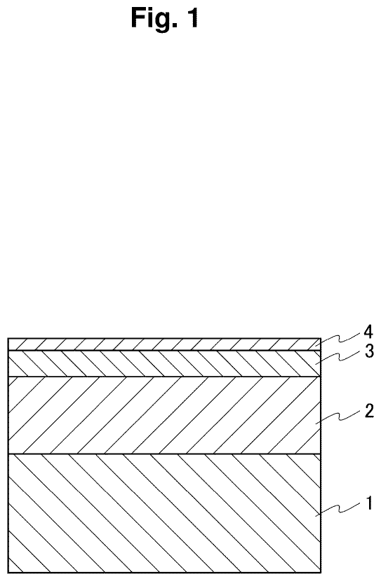

FIG. 1 is a cross-sectional view illustrating an example of a configuration of a semiconductor photoelectrode (nitride semiconductor photoelectrode) according to this embodiment. The semiconductor photoelectrode of this embodiment exerts a catalytic function for oxidation reactions by light such as sunlight and efficiently causes chemical reactions of an oxidation target substance, thereby increasing the durability of a material subjected to light t irradiation. The semiconductor photoelectrode of this embodiment pertains to solar energy conversion technology and fuel generation technology.

The semiconductor photoelectrode illustrated in FIG. 1 includes a conductive membrane 2 formed on a substrate 1, a porous nitride semiconductor membrane 3 formed on the conductive membrane 2, and a promoter layer 4 formed on the porous nitride semiconductor membrane 3. The promoter layer 4 causes a water oxidation reaction on a surface of the promoter layer. The promoter layer 4 may cause the water oxidation reaction on the surface of the promoter layer by being irradiated in an aqueous solution with light opposed to the promoter layer.

The substrate 1 may be a conductive substrate or an insulating substrate. Examples of the substrate 1 include insulating or conductive substrates such as sapphire substrate, GaN substrate, glass substrate, and Si substrate. In the following Examples, a sapphire substrate is used for the substrate 1 but it should be noted that other insulating or conductive substrates such as GaN substrate, glass substrate, and Si substrate also give similar effects.

The conductive membrane 2 may employ a conductive material such as n-GaN membrane, ITO membrane, FTO membrane, and carbon nanotube membrane.

In this embodiment, the porous nitride semiconductor membrane 3 is used as a semiconductor membrane. The porous nitride semiconductor membrane 3 may contain tantalum nitride (Ta₃N₅).

Hereinafter, the porous nitride semiconductor membrane 3 is also referred to as semiconductor membrane 3. The porous nitride semiconductor membrane 3 may have pore sizes ranging from 1 nm to 50 nm.

Examples of the promoter layer 4 include metals of Pt, Pd, Co, Au, Ag, Ru, Cu, Cr, Al, Fe, In, Ni, Rh, Re, Ti, and Si, alloys containing one or more of these metals, and metal oxides of these metals. It is preferable to use a metal oxide such as nickel oxide (NiO) as the promoter layer 4.

The promoter layer 4 desirably has a thickness of 10 nm or less, and particularly, a thickness of 5 nm or less which sufficiently allows light to pass therethrough. The promoter layer 4 may cover a part of a surface of the semiconductor membrane 3.

Considering that light is emitted from the side closer to the promoter layer 4 of a laminate including the promoter layer 4, the semiconductor membrane 3, the conductive membrane 2, and the substrate 1 and that the energy of the light transmitted to the back surface of the substrate 1 is to be utilized effectively, the promoter layer 4, the semiconductor membrane 3, the conductive membrane 2, and the substrate 1 desirably have light transmittance of 80% or more with a thickness of 600 nm to 1800 nm.

### EXAMPLES AND COMPARATIVE EXAMPLES

Hereinafter described are Examples 1 to 3 in which the semiconductor photoelectrode of this embodiment illustrated in FIG. 1 was produced. A semiconductor photoelectrode with no promoter layer will also be described in Comparative Examples 1 to 3.

### Example 1

In Example 1, a sapphire substrate was used for the substrate 1, an n-GaN semiconductor membrane was used for the conductive membrane 2, a tantalum nitride (Ta₃N₅) membrane was used for the semiconductor membrane 3, and NiO was used for the promoter layer 4.

The n-GaN semiconductor membrane was epitaxially grown on a surface of the sapphire substrate by MOCVD. Ammonia gas and trimethylgallium were used as raw materials for the growth, and hydrogen was used as a carrier gas to be sent into a growth furnace. The n-GaN semiconductor membrane had a thickness of 4 μm. The carrier density was 4×10¹⁸ cm⁻³.

Next, a tantalum oxide (Ta₂O₅) membrane having a thickness of about 500 nm was sputter-deposited on the n-GaN semiconductor membrane. Next, as nitriding treatment, the resultant was heated at a temperature of 800° C. or higher while ammonia (NH₃) was allowed to flow at a rate of 2 L/min.

The membrane after the heat treatment was subjected to XRD analysis and identified as a Ta₃N₅ crystal. As a result of cross-sectional SEM observation and cross-sectional TEM observation of the Ta₃N₅ membrane, it was found that the membrane had a porous structure with pore sizes ranging from 1 nm to 50 nm. One hundred pores inside the membrane were detected from a cross-sectional SEM observation image of the Ta₃N₅ membrane. The maximum value of each pore diameter was defined as a pore size, and the sum of the pore sizes was divided by 100, the number of pores, thereby obtaining a mean pore size. The mean pore size was 17 nm, and the total area of the 100 pores was about 3×10⁻¹⁰ cm². The mean pore size is preferably 1 nm to 50 nm, and more preferably 1 nm to 20 nm.

The crystal distortion of the Ta₃N₅ membrane was 0.29, which was calculated by the Williamson-Hall method based on the half width of the peak obtained by XRD analysis of the Ta₃N₅ membrane.

Furthermore, Ni was deposited on a surface of the Ta₃N₅ membrane in the range of 1 to 5 nm using a vacuum vapor deposition device and heated at a temperature of 200° C. or higher, thereby forming a NiO promoter layer.

### Example 2

With regard to a semiconductor photoelectrode in Example 2, a tantalum oxide (Ta₂O₅) membrane was heated at a temperature of 800° C. or higher while ammonia (NH₃) was allowed to flow at a rate of 5 L/min during nitriding treatment. Other conditions are similar to those in Example 1. The crystal distortion of the Ta₃N₅ membrane was 0.34, which was calculated by the Williamson-Hall method based on the half width of the peak obtained by XRD analysis of the Ta₃N₅ membrane.

### Example 3

With regard to a semiconductor photoelectrode in Example 3, a tantalum oxide (Ta₂O₅) membrane was heated at a temperature of 800° C. or higher while ammonia (NH₃) was allowed to flow at a rate of 10 L/min during nitriding treatment. Other conditions are similar to those in Example 1. The crystal distortion of the Ta₃N₅ membrane was 0.36, which was calculated by the Williamson-Hall method based on the half width of the peak obtained by XRD analysis of the Ta₃N₅ membrane.

### Comparative Example 1

A semiconductor photoelectrode in Comparative Example 1 was produced without forming a promoter layer. In Comparative Example 1, a Ta₂O₅ membrane was sputter-deposited on an n-GaN membrane and subjected to nitriding treatment to obtain a porous tantalum nitride membrane, whereby an electrode was produced without forming a promoter layer. Other conditions are similar to those in Example 1. The flow rate of ammonia (NH₃) during the nitriding treatment was set to 2 L/min as similar to Example 1.

### Comparative Example 2

A semiconductor photoelectrode of Comparative Example 2 was produced without forming a promoter layer. In Comparative Example 2, a Ta₂O₅ membrane was sputter-deposited on an n-GaN membrane and subjected to nitriding treatment to obtain a porous tantalum nitride membrane, whereby an electrode was produced without forming a promoter layer. Other conditions are similar to those in Example 2. The flow rate of ammonia (NH₃) during the nitriding treatment was set to 5 L/min as similar to Example 2.

### Comparative Example 3

A semiconductor photoelectrode of Comparative Example 3 was produced without forming a promoter layer. In Comparative Example 3, a Ta₂O₅ membrane was sputter-deposited on an n-GaN membrane and subjected to nitriding treatment to obtain a porous tantalum nitride membrane, whereby an electrode was produced without forming a promoter layer. Other conditions are similar to those in Example 3. The flow rate of ammonia (NH₃) during the nitriding treatment was set to 10 L/min as similar to Example 3.

### <Redox Reaction Test>

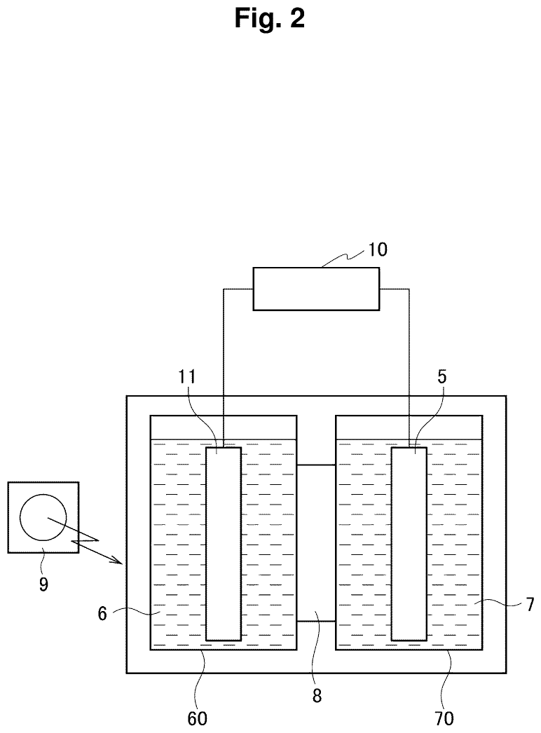

In Examples 1 to 3 and Comparative Examples 1 to 3, redox reactions were tested using a device illustrated in FIG. 2.

The device illustrated in FIG. 2 includes an oxidation tank 60 and a reduction tank 70. An aqueous solution 6 is poured into the oxidation tank 60, and an oxidizing electrode 11 is put into the aqueous solution 6. An aqueous 7 is poured into the reduction tank 70, and a reducing electrode 5 is put into the aqueous solution 7.

A 1 mol/L potassium hydroxide solution was employed for both the aqueous solution 6 in the oxidation tank 60 and the aqueous solution 7 in the reduction tank 70. Other than the potassium hydroxide solution, the aqueous solution 6 may employ a sodium hydroxide solution, cesium hydroxide solution, rubidium hydroxide solution, or hydrochloric acid solution. Other than the potassium hydroxide solution, the aqueous solution 7 may employ a sodium hydroxide solution, rubidium hydroxide solution, cesium hydroxide solution, sodium hydrogen carbonate solution, potassium hydrogen carbonate solution, potassium chloride solution, or sodium chloride solution.

As the oxidizing electrode 11, a semiconductor photoelectrode to be tested was used. Specifically, in each of the semiconductor photoelectrodes in Examples 1 to 3 and Comparative Examples 1 to 3, the Ta₃N₅ membrane provided with a NiO layer was scratched, and a conductive wire was connected to a part of the surface and soldered using indium (In). After that, the indium was coated with epoxy resin not to expose its surface, and the resultant was placed as the oxidizing electrode 11 illustrated in FIG. 2.

Platinum (available from The Nilaco Corporation) was used for the reducing electrode 5. The reducing electrode 5 preferably includes a metal or a metal compound. Nafion (registered trademark) was used as an electrolyte membrane 8. An area of 1 cm² in the oxidizing electrode 11 was used as a sample, and a light source 9 was fixed to oppose the side with the exposed NiO promoter layer.

As the light source 9, a 300 W high-pressure xenon lamp (illuminance of about 34 mW/cm² at a wavelength of 600 nm or less) was used to uniformly irradiate the oxidizing electrode 11 (semiconductor photoelectrode) with light. The light source 9 preferably emits light having a wavelength that can be absorbed by a material used for the semiconductor photoelectrode serving as the oxidizing electrode 11. Examples of the light source 9 include a xenon lamp, pseudo-sunlight source, halogen lamp, mercury lamp, and sunlight. Combinations of these light sources are also employable.

A power source 10 was connected between the oxidizing electrode 11 (semiconductor photoelectrode) and the reducing electrode 5, thereby applying a voltage of 2 V. Examples of the power source 10 include commercial power sources, solar cells, and other power sources derived from renewable energy. Combinations of these power sources are also employable.

In this test, the temporal change in photocurrent value between the oxidizing electrode 11 and the reducing electrode 5 was measured for 40 hours from the start of light irradiation.

Hydrogen was the target to be produced in Examples, but changing the metal of the reducing electrode 5 (to, for example, Ni, Fe, Au, Pt, Ag, Cu, In, Ti, Co, or Ru) or changing an atmosphere inside a cell enables production of a carbon compound through reduction reactions of carbon dioxide or production of ammonia through reduction reactions of nitrogen.

### <Experimental Result>

Table 1 shows photocurrent densities 1 minute and 40 hours after the light irradiation and photocurrent retention rates after 40 hours in Examples and Comparative Examples.

The photocurrent densities and the photocurrent retention rates were calculated from the following Formulae (5) and (6).

$$\begin{matrix}[ Math . 2 ] & \\ Photocurrent density = \frac{Photocurrent value}{Light irradiation area of semiconductor photoelectrode} ( A / {cm}^{2} ) & ( 5 )\end{matrix}$$

$$Photocurrent retention rate = \frac{Photocurrent density after 40 hours}{Photocurrent density after 1 minute} \times 100 ( \% ) \qquad ( 6 )$$

TABLE 1

| | | | Photocurrent Density | | Photocurrent |
|---|---|---|---|---|---|
| | | | (mA/cm²) | | Retention |
| | NH₃ Flow Rate | Promoter | After 1 | After 40 | Rate After 40 |
| | (L/min) | Layer | Minute | Hours | Hours (%) |
| Example 1 | 2 | Applicable | 0.24 | 0.15 | 62 |
| Example 2 | 5 | Applicable | 0.15 | 0.11 | 73 |
| Example 3 | 10 | Applicable | 0.12 | 0.10 | 83 |
| Comparative | 2 | N/A | 0.28 | 0.0041 | 1.5 |
| Example 1 | | | | | |
| Comparative | 5 | N/A | 0.17 | 0.0071 | 4.1 |
| Example 2 | | | | | |
| Comparative | 10 | N/A | 0.12 | 0.0029 | 2.4 |
| Example 3 | | | | | |

In Comparative Examples 1 to 3, the photocurrent retention rates 40 hours after the light irradiation were as extremely low as 5% or less, but in Examples 1 to 3, the photocurrent retention rates were as high as 62% to 83%. These results show that Ta₃N₅ membranes having crystal distortion within the range from 0.29 to 0.36 increased the duration of a water oxidation reaction due to the formation of the promoter layer despite the crystal distortion.

In addition, when monitoring the surface of each semiconductor photoelectrode after 40 hours, it was found that the red Ta₃N₅ membrane in each Comparative Example was completely detached, but in Examples 1 to 3, 65%, 77%, and 90% of the respective Ta₃N₅ membranes remained attached without being detached from the surface area of the semiconductor photoelectrodes.

Based on the results, it is considered that Examples improved in photocurrent retention rate (that is, increased the duration) as compared with Comparative Examples because the Ta₃N₅ membranes in Examples were prevented from being detached. The detachment of each Ta₃N₅ membrane associated with the desorption of oxygen was prevented presumably because of oxygen generation reactions selectively generated on the surface of the promoter layer due to water oxidation, thereby preventing reactions inside the porous Ta₃N₅ membrane and at an interface between the Ta₃N₅ membrane and n-GaN.

Furthermore, the photocurrent densities from the start to 40 hours after the light irradiation were higher in the order of Examples 1, 2, and 3 at all points in time. A smaller photocurrent density tends to cause a higher photocurrent retention rate after 40 hours. This tendency indicates that the smaller the number of reactions, the longer the duration.

As described above, the semiconductor photoelectrode according to this embodiment includes the conductive membrane formed on the substrate, the porous nitride semiconductor membrane formed on the conductive membrane, and the promoter layer formed on the porous nitride semiconductor membrane, and the promoter layer causes an oxidation reaction of water on a surface of the promoter layer.

In this manner, in this embodiment, pores of the porous nitride semiconductor membrane are covered with the promoter layer, and water oxidation reactions are selectively caused on the promoter layer which is the outermost surface. Accordingly, it is possible to prevent reactions inside the conductive membrane 2 and at an interface between the conductive membrane 2 and the porous nitride semiconductor membrane 3. Therefore, the porous nitride semiconductor membrane 3 is prevented from being detached, thereby increasing the duration of a photoelectrochemical water splitting reaction.

In addition, using the semiconductor photoelectrode of this embodiment allows water oxidation reactions and proton reduction reactions to proceed by light irradiation (allows photoelectrochemical water splitting reactions to proceed).

### REFERENCE SIGNS LIST

1 SUBSTRATE
2 CONDUCTIVE MEMBRANE
3 POROUS NITRIDE SEMICONDUCTOR MEMBRANE (SEMICONDUCTOR MEMBRANE)
4 PROMOTER LAYER

1. A nitride semiconductor photoelectrode comprising:
a conductive membrane formed on a substrate;
a porous nitride semiconductor membrane formed on the conductive membrane; and
a promoter layer formed on the porous nitride semiconductor membrane,
wherein the promoter layer causes an oxidation reaction of water on a surface of the promoter layer.

2. The nitride semiconductor photoelectrode according to claim 1,
wherein the porous nitride semiconductor membrane contains tantalum nitride (Ta₃N₅).

3. The nitride semiconductor photoelectrode according to claim 1,
wherein the porous nitride semiconductor membrane has a mean pore size of 50 nm or less.

4. The nitride semiconductor photoelectrode according to claim 1,
wherein the promoter layer causes the oxidation reaction by being irradiated in an aqueous solution with light opposed to the promoter layer.

5. The nitride semiconductor photoelectrode according to claim 1,
wherein the promoter layer contains a metal oxide.

6. The nitride semiconductor photoelectrode according to claim 2,
wherein the promoter layer contains a metal oxide.

7. The nitride semiconductor photoelectrode according to claim 3,
wherein the promoter layer contains a metal oxide.

8. The nitride semiconductor photoelectrode according to claim 4,
wherein the promoter layer contains a metal oxide.
